(19) United States
(12) Patent Application Publication
(10) Pub. No.: US 2013/0075629 A1
(43) Pub. Date: Mar. 28, 2013

(54) TERAHERTZ WAVE GENERATOR

(71) Applicants: Atsushi Doi, Kokubunji-shi (JP); Mitsuru Namiki, Hanno-shi (JP)

(72) Inventors: Atsushi Doi, Kokubunji-shi (JP); Mitsuru Namiki, Hanno-shi (JP)

(73) Assignee: OLYMPUS CORPORATION, Tokyo (JP)

(21) Appl. No.: 13/636,937

(22) PCT Filed: Mar. 8, 2011
(86) PCT No.: PCT/JP2011/001360

§ 371 Date: Nov. 27, 2012

(30) Foreign Application Priority Data
Mar. 24, 2010 (JP) 2010-068389

(51) Int. Cl. G02F 1/37; G02F 1/355

(52) U.S. Cl. 250/504 R

(57) ABSTRACT

A terahertz wave generator includes a femtosecond pulse light source 1 that outputs a near-infrared light L₁, which is a pulse light, a diffraction grating 2 that diffracts the outputted near-infrared light L₁, an optical system including a lens 3 and a lens 5, and a LiNbO₃ crystal 6 for generating terahertz waves L₂ with irradiation of the near-infrared light L₁. The optical system including the lens 3 and the lens 5 is arranged such that at least a pan of a plane S₀′ optically conjugated to a diffractive plane S₀ of the diffraction grating 2 is formed within the LiNbO₃ crystal 6, and a direction normal to the conjugated plane and a direction normal to a plane formed by the pulse front of the non-linear L₁ are matched with each other within the LiNbO₃ crystal 6. This makes it possible for the near-infrared light L₁ to cause the nonlinear optical effect to efficiently occur in the wide range, whereby high-efficient and high-power terahertz waves can be obtained.

### TECHNICAL FIELD

The present invention relates to a terahertz wave generator that generates high-power terahertz waves.

### BACKGROUND ART

Conventionally, in a field of sensing and imaging of transparent substance (for example, water), there have been known techniques that employ terahertz waves.

Recently, in particular, the terahertz wave technology has been rapidly developing with the establishment of methods of generating and detecting the terahertz waves. However, the conventional terahertz wave generators cannot sufficiently increase efficiency in generating terahertz waves, and its output power is insufficient for use in the large-diameter terahertz wave imaging, or in the field of application using the large-diameter terahertz wave imaging such as sensing.

Further, recently, there is proposed a method of generating high-output terahertz waves utilizing difference frequency mixing, which is one type of nonlinear optical effects (see, for example, “Efficient terahertz generation by optical rectification at 1035 nm” M. C. Hoffmann, K.-L. Yeh, J. Hebling, and K. A. Nelson, Opt. Express 15 (2007) 11706. (hereinafter, referred to as Hoffmann et al)). In this method, nonlinear optical crystal (for example, lithium niobate (LiNbO₃) crystal) having large second-order nonlinear optical coefficient is irradiated with near-infrared laser pulse in which a plane (hereinafter, referred to as “pulse front”) formed by connecting intensity peaks of the pulse is tilted by a diffraction grating to meet the phase matching condition, so that high-output terahertz waves can be generated.

In general, in order to implement the difference frequency mixing, it is necessary to satisfy the following phase matching condition.

[Math.1]

ν_{NIR}^{gr}=ν_{THz}^{ph} (1)

where ν_{NIR}^{gr} is a group velocity of near-infrared light pulse incident to the nonlinear optical crystal, and ν_{THz}^{ph} is a phase velocity of terahertz waves generated with the difference frequency mixing. In most cases, the LiNbO₃ crystal exhibits ν_{NIR}^{gr}>>ν_{THz}^{ph}, which does not satisfy Expression (1), and hence, the high-output terahertz waves cannot be generated. However, Hoffmann et al satisfies the phase matching conditions by employing a method of tilting the pulse front of the near-infrared light pulse, and succeeds in generating the high-output terahertz waves. In this method, by tilting the pulse front, the phase matching condition of Expression (2) is satisfied.

[Math.2]

ν_{NIR}^{gr} cos θ_{c}=ν_{THz}^{ph} (2)

where, θ_{c} is a tilting angle of the pulse front of the near-infrared laser pulse, the optimum angle of which tilting angle is determined according to frequency of the terahertz waves to be generated and of the near-infrared laser pulse.

It should be noted that the difference frequency mixing means that two electromagnetic waves having different wavelengths are inputted to generate an electromagnetic wave having frequency equal to the difference in frequency between the two electromagnetic wavelengths. However, in Hoffmann et al, the difference frequency mixing is not implemented by inputting two types of laser lights or electromagnetic waves having different wavelengths to generate the electromagnetic waves having the wavelength equal to the difference in frequency between the two inputted lights, but is implemented between two wavelength components from among wavelength components of near-infrared laser pulse having finite spectrum width to generate terahertz waves. Since the difference frequency mixing occurs between various wavelength components, the wavelength of the obtained terahertz waves has a spectrum width to some degree.

### SUMMARY OF INVENTION

### Technical Problem

In the terahertz wave generator described in Hoffmann et al, the near-infrared light pulse having pulse front tilted by grating through a diffraction grating is made transmit in a LiNbO₃ crystal through an optical system (lens), thereby to generate a difference frequency having a wavelength satisfying the phase matching condition of Expression (2). At this time, it is necessary that the lights of the respective wavelength components used for generating the difference frequency be spatially overlapped at a position in the crystal where the terahertz waves are generated. Therefore, the difference frequency occurs in a wide area of the pulse front when the lights of the respective wavelengths diffracted at given points in the diffraction grating and passing through spatially different paths are gathered again at the position where the terahertz waves are generated, in other words, on a plane of the pulse front passing through the crystal, whereby generation efficiency of the terahertz waves increases. This means that a plane optically conjugated to the diffraction grating exists in the crystal in a manner that the conjugated plane is tilted at an angle equal to the tilted angle of the pulse front that satisfies the phase matching conditions. However, in Hoffmann et al, emphasis is on tilting the pulse front at the angle that satisfies the phase matching in the crystal, and little consideration is paid to the existence of the plane optically conjugated to the diffraction grating in the crystal at the angle equal to the tilting angle of the front pulse that satisfies the phase matching condition. For this reason, it is only a part on the pulse front that strictly satisfies the phase matching condition, even if the pulse front of the pulse is tilted such that the tilting angle of the pulse front of the pulse is a desired angle that satisfies Expression (2). As a result, the generation efficiency of the terahertz waves decreases, although a nonlinear optical crystal having large second-order nonlinear optical coefficient is used and the phase matching conditions are satisfied by tilting the pulse front of the pulse.

The present invention is made in view of the problem described above, and an object of the present invention is to provide a high-power terahertz wave generator that satisfies phase matching conditions in the entire range of a tilted pulse front.

### Solution to Problem

To achieve the object above, according to the present invention, there is provided a terahertz wave generator, which includes: a source of an electromagnetic wave for outputting a first electromagnetic wave; a diffraction element for diffracting the first electromagnetic wave; an optical system for transmitting the first electromagnetic wave diffracted by the diffraction element; and, a nonlinear optical crystal for generating a second electromagnetic wave with irradiation of the first electromagnetic wave transmitted by the optical system, in which the second electromagnetic wave is a pulse-formed terahertz wave; the first electromagnetic wave is a pulse-formed electromagnetic wave having shorter wavelength than that of the terahertz wave; a pulse front of the first electromagnetic wave is tilted within the nonlinear optical crystal such that the first electromagnetic wave satisfies a phase matching condition for generating the second electromagnetic wave within the nonlinear optical crystal by a nonlinear optical effect; at least a part of a plane optically conjugated to a diffractive plane of the diffraction element is formed in the nonlinear optical crystal; and, the diffraction element, the optical system and the nonlinear optical crystal are configured such that a direction normal to the conjugated plane in the nonlinear optical crystal and a direction normal to a plane formed by the pulse front of the first electromagnetic wave in the nonlinear optical crystal are matched with each other.

According to the present invention, it is possible to satisfy the phase matching condition of Expression (2) in the entire range of the pulse front, by diffracting the electromagnetic wave in a pulse form (first electromagnetic wave) outputted from the source of the electromagnetic wave by the diffraction element, and tilting a pulse front, which is a plane formed by connecting intensity peaks of the pulse, of the first electromagnetic wave as compared with that before diffraction. More specifically, a component of a group velocity of the first electromagnetic wave in the direction of the second electromagnetic wave is coincided with the phase velocity of the second electromagnetic wave within the nonlinear optical crystal. Further, the plane optically conjugated to the diffractive plane of the diffraction grating is tilted at an angle equal to the pulse front of the first electromagnetic wave in the nonlinear optical crystal, more specifically, the direction normal to the plane conjugated to the diffractive plane of the diffraction element is matched with the direction normal to the pulse front, whereby it is possible to produce the nonlinear optical effect in a state where lights with the respective wavelengths whose optical paths have been separated by the diffraction grating are precisely overlapped spatially in the nonlinear optical crystal. Further, the light density of the first electromagnetic wave increases in the nonlinear optical crystal, whereby it is possible to obtain strong difference frequency mixing. This makes it possible to generate high-power terahertz waves (second electromagnetic wave) with significantly high efficiency.

It should be noted that the first electromagnetic wave and the second electromagnetic wave of the present invention include light, especially, near-infrared light and terahertz wave, and the source of the electromagnetic wave includes a laser for generating the first electromagnetic wave.

In the present invention, the optical system may include both-side telecentric optical system.

With this configuration, when the first electromagnetic wave diffracted at the respective positions on the diffraction element is image-formed on the plane optically conjugated to the diffractive plane of the diffraction element in the nonlinear optical crystal at the time of generation of the terahertz waves in the nonlinear optical crystal, the traveling directions of the first electromagnetic wave are parallel to each other at each image height, and hence, the same phase matching condition is established in the entire area of the plane optically conjugated to the diffraction element. This makes it possible to enhance the efficiency in generation of the terahertz waves.

In the present invention, the nonlinear optical crystal may be a LiNbO₃ crystal or LiTaO₃ crystal.

With this configuration, significantly high-power terahertz waves can be generated by using the LiNbO₃ crystal or LiTaO₃ crystal having large second-order nonlinear optical coefficient.

In the present invention, the first electromagnetic wave outputted from the source of the electromagnetic wave may be the near-infrared light.

With this configuration, it is possible to use a titanium-sapphire laser, which is often used as the femtosecond pulse laser. Further, in a case where the present invention is applied to a terahertz time-domain spectroscopy for detecting the terahertz waves by using the titanium-sapphire laser, the same light source can be used for both detection of the terahertz waves and generation of the terahertz waves, whereby it is possible to reduce the number of the light source.

### Advantageous Effects of Invention

According to the present invention, it is possible to provide a high-efficient and high-power terahertz wave generator that can produce the nonlinear optical effect in the wide range with high efficiency.

### BRIEF DESCRIPTION OF DRAWINGS

FIG. 1 is a diagram illustrating a schematic configuration of a terahertz wave generator according to a first embodiment of the present invention.

FIG. 2 is a diagram illustrating a schematic configuration of a terahertz wave generator according to a second embodiment of the present invention.

FIG. 3 is a diagram for explaining a configuration and operation of a nonlinear optical crystal used in a terahertz wave generator according to a third embodiment of the present invention.

### DESCRIPTION OF EMBODIMENTS

Hereinbelow, embodiments according to the present invention will be described with reference to the drawings.

### First Embodiment

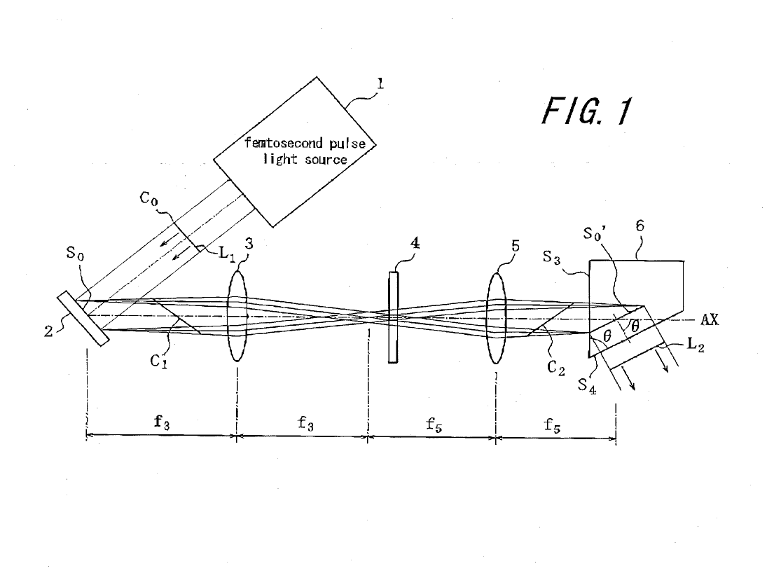

FIG. 1 is a diagram illustrating a schematic configuration of a terahertz wave generator according to a first embodiment of the present invention. The terahertz wave generator includes a femtosecond pulse light source 1 serving as a source of an electromagnetic wave, a diffraction grating 2 serving as a diffraction element, a lens 3, a one-half wavelength plate 4, a lens 5, and a LiNbO₃ crystal 6 serving as a nonlinear optical crystal. The lens 3, the one-half wavelength plate 4 and the lens 5 constitute an optical system for transmitting electromagnetic waves that have been diffracted by the diffraction grating.

The femtosecond pulse light source 1 is a light source for generating a near-infrared light L₁ in a pulse form, and employs, for example, a titanium-sapphire laser capable of generating broadband infrared pulses with a wavelength range of 750 to 850 nm.

The diffraction grating 2 is disposed on an optical path on which the near-infrared light L₁ outputted from the femtosecond pulse light source 1 is transmitted, and diffracts the near-infrared light L₁ to an optical axis directions of the lens 3 and the lens 5. More specifically, the diffraction grating 2 is also located on the optical axes of the lens 3 and the lens 5. Further, a diffractive plane of the diffraction grating 2 is tilted at a predetermined angle with respect to the optical axes of the lens 3 and the lens 5. This angle is determined according to the configuration of the optical system including the lens 3 and the lens 5 as described later.

Each of the lens 3 and the lens 5 is a lens in which the respective optical axes thereof are aligned with each other and the refractive powers thereof are positive, and transmits the near-infrared light L₁ that has been diffracted by the diffraction grating 2 into the inside of the nonlinear optical crystal 6. The optical system including the lens 3 and the lens 5 is configured such that: the near-infrared light L₁ diffracted at a given point on the diffraction grating 2 spreads (is diffracted) radially in accordance with different wavelength components; the lens 3 changes the respective wavelengths into lights parallel to each other; the lens 5 gathers the lights on an image forming point in the LiNbO₃ crystal 6; and, the respective wavelengths are gathered again. Further, the one-half wavelength plate 4 disposed between the lens 3 and the lens 5 adjusts a polarization direction of the near-infrared light L₁ that has been diffracted by the diffraction grating 2, such that the effect of the difference frequency mixing is made strong at the LiNbO₃ crystal 6.

Further, the lens 3 and the lens 5 are disposed such that a plane S₀′ optically conjugated to a diffractive plane S₀ of the diffraction grating is formed in the LiNbO₃ crystal 6. For example, a both-side telecentric optical system can be obtained, in which, when focal lengths of the lens 3 and the lens 5 are denoted by f₃ and f₅, respectively, f₃ is a distance from the diffractive plane S₀ to the lens 3; a distance from the lens 3 to the lens 5 is the sum of f₃ and f₅; and, f₅ is a distance from the lens 5 to an image forming plane (conjugated plane S₀′) in the LiNbO₃ crystal. Further, the tilting angle of the diffractive plane S₀ of the diffraction grating 2 and the total magnification of the lens 3 and the lens 5 are determined such that a direction normal to the plane S₀′ conjugated to the diffractive plane S₀ and a direction normal to the pulse front of the pulse of the near-infrared light L₁ are matched with each other in the LiNbO₃ crystal 6.

The LiNbO₃ crystal 6 is a nonlinear optical crystal for generating terahertz waves, which are second electromagnetic waves, with irradiation of the near-infrared light. As illustrated in FIG. 1, the LiNbO₃ crystal 6 has a plane S₃ perpendicular to an optical axis AX, and plane S₄ oriented at an angle θ with respect to the plane S₃. The crystal is shaped such that the near-infrared light L₁ perpendicularly enters the plane S₃, and the terahertz waves L₂ generated in the crystal exits perpendicularly from the plane S₄, so as to prevent generation of deflection caused by refraction. With this shape, the incident direction of the near-infrared light L₁ to the LiNbO₃ crystal, and the outgoing direction of the terahertz waves L₂ from the LiNbO₃ crystal 6 can be known without considering the refraction, whereby alignment operation can be made easy at the time of configuring the device. Note that, in FIG. 1, a direction perpendicular to the paper surface corresponds to the Z axis of the LiNbO₃ crystal 6. Further, θ represents an angle that satisfies Expression (2) described above, and is optimally determined in accordance with the terahertz waves and frequency of the near-infrared laser pulse to be generated.

With the configuration as described above, the near-infrared light L₁ outputted from the femtosecond pulse light source 1 is diffracted by the diffraction grating 2, passes through the lens 3, the one-half wavelength plate 4 and the lens 5, and is irradiated onto the LiNbO₃ crystal 6. Here, a pulse front C₀ of the pulse of the near-infrared light L₁ before entering the diffraction grating 2 faces the direction perpendicular to the traveling direction of the near-infrared light L₁. On the other hand, a pulse front C₁ of the pulse of the near-infrared light L₁ deflected by the diffraction grating 2 does not face the direction perpendicular to the traveling direction of the near-infrared light L₁, and forms a certain tilting angle with respect to the traveling direction. Then, the near-infrared lights L₁ passing through the lens 3 and the lens 5 are gathered on the LiNbO₃ crystal 6 in a state where a pulse front C₂ of the pulse is tilted with respect to the traveling direction of the near-infrared light L₁.

Here, the tilting angle of the pulse front of the pulse of the near-infrared light L₁ gathered in the LiNbO₃ crystal 6 is determined in accordance with the tilting angle of the diffractive plane S₀ of the diffraction grating 2 and the total magnification of the lens 3 and the lens 5. More specifically, the pulse front of the pulse of the near-infrared light L₁ is tilted at the time when deflected by the diffraction grating 2, and the resulting tilting angle is further changed in accordance with the total magnification of the lens 3 and the lens 5 at the time when the pulse front passes through the lens 3 and the lens 5.

On the other hand, the angle of diffraction of the near-infrared light L₁ diffracted by the diffraction grating 2 varies according to wavelengths, and hence, the near-infrared light L₁ diffracted at a given point is outputted radially in the different directions according to the respective wavelengths. Then, the lights with the respective wavelengths of the near-infrared light L₁ diffracted at a given point on the diffraction grating 2 pass through the lens 3 and the one-half wavelength plate 4, and are gathered again on the plane S₀′ conjugated to the diffractive plane S₀ in the LiNbO₃ crystal 6 by the lens 5. More specifically, the respective wavelengths of the near-infrared light L₁ are gathered on the conjugated plane S₀′ in high density, and hence, the difference frequency mixing occurs efficiently. Therefore, by improving the image formation state of the near-infrared light in the LiNbO₃ crystal 6, it is possible to enhance the efficiency of the difference frequency mixing, and to increase the intensity of the generated terahertz waves.

Here, in the LiNbO₃ crystal 6, the near-infrared light L₁ whose pulse front of the pulse is tilted causes the difference frequency mixing to occur between the different wavelength components of the near-infrared light L₁, and the terahertz waves L₂ are generated. For this reason, the terahertz waves can be efficiently generated in a case where the image forming plane of the near-infrared light L₁ is tilted at the angle same as the pulse front angle of the pulse. Further, by employing the telecentric optical system in which principal rays at respective image heights are parallel to the optical axis, the light whose image is formed on the conjugated plane S₀′ of the diffraction grating 2 in the LiNbO₃ crystal 6 is transmitted parallel to each other at each image height, and hence, the same phase matching condition is established in the entire range of the conjugated plane S₀′. This makes it possible to enhance the generation efficiency of the terahertz waves L₂. More specifically, the terahertz waves can be generated collinearly and most efficiently under the conditions that; the tilting angle of the pulse front of the pulse satisfies the specific angle; the plane optically conjugated to the diffractive plane of the diffraction grating exists in the LiNbO₃ crystal 6 in a manner that the conjugated plane is tilted at an angle equal to the tilted angle of the pulse front of the pulse; and, the near-infrared light L₁ enters the LiNbO₃ crystal 6 in the telecentric state.

In FIG. 1, the near-infrared light L₁ can enter the LiNbO₃ crystal 6 in the telecentric state, because each constituent element is configured such that, when the focal lengths of the lens 3 and the lens 5 are denoted by f₃ and f₅, respectively, f₃ is a distance from the diffraction grating 2 to the lens 3; a distance from the lens 3 to the lens 5 is the sum of f₃ and f₅; and, f₅ is an optical distance from the lens 5 to an image forming plane in the LiNbO₃ crystal.

Further, the tilting angle of the plane S₀′ optically conjugated to the diffractive plane S₀ of the diffraction grating 2 in the LiNbO₃ crystal 6 depends not only upon the angle of the diffraction grating, but also upon the total magnification of the lens 3 and the lens 5 (Scheimpflug principle). More specifically, both the tilting angle of the pulse front of the pulse and the tilting angle of the plane optically conjugated to the diffractive plane of the diffraction grating 2 depend upon the diffraction grating 2 and the total magnification of the lens 3 and the lens 5. Therefore, by arranging the diffraction grating, the lens 3 and the lens 5 as illustrated in FIG. 1, it is possible to satisfy the conditions that the tilting angle of the pulse front of the pulse satisfies the specific angle; the plane S₀′ optically conjugated to the diffractive plane S₀ of the diffraction grating 2 exists in the LiNbO₃ crystal in a manner that the conjugated plane S₀′ is tilted at an angle equal to the tilted angle of the pulse front of the pulse; and, the near-infrared light L₁ enters the LiNbO₃ crystal 6 in the telecentric state. With this configuration, it is possible to generate the significantly-high-power terahertz waves.

As described above, according to this embodiment, in the LiNbO₃ crystal, the plane optically conjugated to the diffractive plane of the diffraction grating is tilted at an angle equal to the tilted angle of the pulse front of the pulse, more specifically, the direction normal to the plane conjugated to the diffractive plane and the direction normal to the pulse front are coincided with each other. Therefore, the phase matching conditions are satisfied while distortion of the optical system is suppressed, whereby the high-power terahertz waves can be generated in the wide range of the crystal. Further, since the both-side telecentric is employed as the optical system formed by the lens 3 and the lens 5, the terahertz waves can be efficiently generated in the wide range of the crystal.

### Second Embodiment

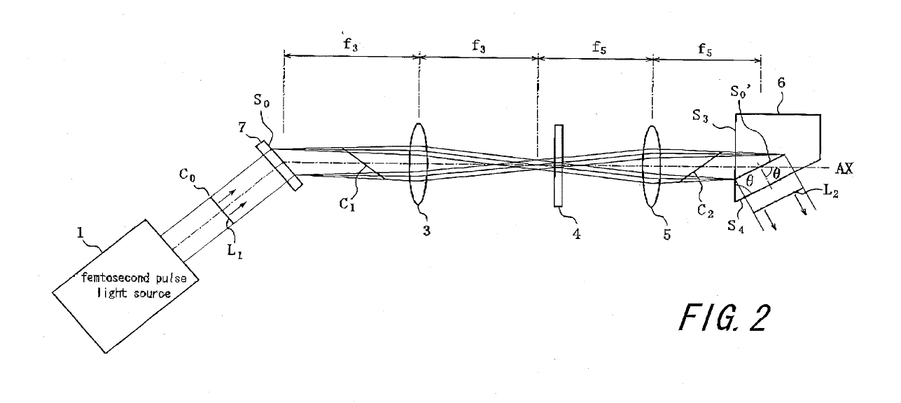

FIG. 2 is a diagram illustrating the schematic configuration of a terahertz wave generator according to a second embodiment of the present invention. In this embodiment, the reflection-type diffraction grating 2 employed in the terahertz wave generator according to the first embodiment is replaced with a transmission-type diffraction grating 7. With this replacement, the femtosecond pulse light generator 1 is disposed such that the diffraction grating 7 is irradiated with the near-infrared light L₁ from the back side of the diffraction grating 7. The other configurations are the same as those in the first embodiment. Therefore, the same reference characters are attached to the same constituent elements, and explanation thereof will be omitted.

With this configuration, the near-infrared light L₁ entering the diffraction grating 7 is not blocked by the lens 3 even when the lens 3 having short focal length f₃ is selected. Therefore, in addition to the effect obtained by the first embodiment, the above-described configuration increases the degree of freedom in terms of the configuration of the optical system.

### Third Embodiment

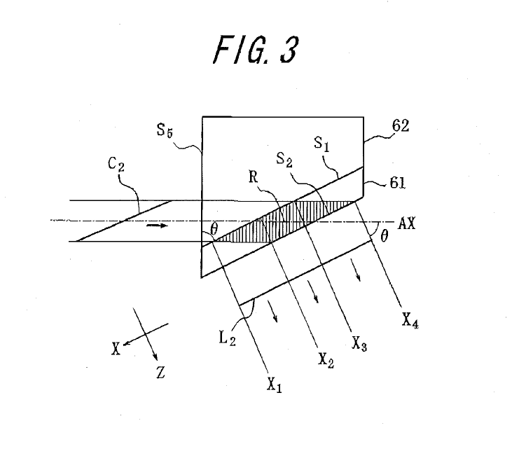

FIG. 3 is a diagram for explaining a configuration and operation of a nonlinear optical crystal used in a terahertz wave generator according to a third embodiment of the present invention. In the third embodiment, the LiNbO₃ crystal 6 in the first embodiment is replaced with LiNbO₃ crystals 61, 62, which will be described below. The other configurations are the same as those in the first embodiment.

In FIG. 3, the nonlinear optical crystal is formed by two LiNbO₃ crystals 61, 62, The LiNbO₃ crystal 62 has a plane S₅ perpendicular to an optical axis AX of the near-infrared light L₁, and a plane S₁ oriented at an angle θ with respect to the plane S₅, Further, the LiNbO₃ crystal 62 is jointed with the LiNbO₃ crystal 61 having a plane 52 parallel to the plane S₁. Similar to the case in the first embodiment, the angle θ is a tilting angle of the pulse front of the near-infrared light L₁ for satisfying above-described Expression (2), which is a phase matching condition. The LiNbO₃ crystals 61, 62 are disposed such that the near-infrared light L₁ enters the LiNbO₃ crystal 62, passes through the plane S₁, and, then enters the LiNbO₃ crystal 61. The LiNbO₃ crystal 61 is a LiNbO₃ crystal for generating the high-power terahertz waves L₂ with the irradiation of the near-infrared light pulse L₁, and the LiNbO₃ crystal 62 is a LiNbO₃ crystal arranged in a direction in which the phase matching condition for generating the terahertz waves is not satisfied even if the near-infrared light pulse L₁ is irradiated in the arrangement illustrated in FIG. 8.

When the near-infrared light L₁ is irradiated onto the LiNbO₃ crystals 62, 61, the terahertz waves are not generated in the LiNbO₃ crystal 62. The high-power terahertz waves L₂ are generated when the pulse front of the near-infrared light L₁ passes through a region R in the crystal 61. The terahertz waves L₂ exit in a direction perpendicular to the plane S₂, which is an exiting plane and is opposite to the plane S₁, and hence, the terahertz waves are emitted from the LiNbO₃ crystal 61 in a width between X₁ and X₄ in FIG. 3. At this time, when the near-infrared light pulse L₁ passes through the region R, and the terahertz waves generated at each position in the region R reinforce each other in the same phase, so that the high-power terahertz waves can be outputted. Since the LiNbO₃ crystal 61 is shaped such that the plane S₁ and the plane S₂ are parallel to each other, the intensities of the terahertz waves L₂ generated in a width between X₂ and X₃, the width in which the terahertz waves L₂ reinforce each other in the same phase, keep high values and almost equal. By using the terahertz waves generated in this width between X₂ and X₃, it is possible to achieve the terahertz wave light source that can produce high-power terahertz waves having spatially uniform intensity, which is applicable to measurement requiring spatially uniform illumination light such as imaging measurement.

It should be noted that the effect of refraction of the near-infrared light L₁ when entering the LiNbO₃ crystal 61 can be reduced by bringing the LiNbO₃ crystal 62 into contact with the LiNbO₃ crystal 61. Further, by disposing the plane S₅ of the LiNbO₃ crystal 62 so as to be perpendicular to the optical axis of the near-infrared light L₁, it is possible to eliminate the effect of refraction of the near-infrared light L₁ even at the time of entering the crystal 62. Therefore, the LiNbO₃ crystal 62 makes conditions of the near-infrared light pulse L₁ entering the crystal easy. However, in place of the LiNbO₃ crystal 62, it may be possible to employ a material that allows the near-infrared light L1 to pass through such as a glass material. Further, it may be possible to employ a structure in which the crystal 62 does not exist. In this case, it is necessary to consider the effect of refraction at the time when the near-infrared light L₁ enters the LiNbO₃ crystal 61.

Further, in FIG. 3, the shape of the LiNbO₃ crystal 61 is specified to provide a region where distribution of spatial strength of the generated terahertz waves is uniform. In addition, rather than specifying the shape of the crystal, it is possible to make the distribution of the spatial strength of the terahertz waves uniform, by increasing the numerical aperture of the near-infrared light L₁ irradiated onto the LiNbO₃ crystal 61, and narrowing the region located before or after the image forming position where the light intensity is high in the traveling direction of the near-infrared light L₁, thereby to restrict the region where the difference frequency mixing occurs.

It should be noted that the present invention is not limited to the embodiments described above, and it may be possible to make various modification and changes. For example, in the embodiments described above, the LiNbO₃ crystal is employed as the nonlinear optical crystal having large second-order nonlinear optical coefficient. However, in place of this, it may be possible to use other nonlinear optical crystal such as a LiTaO₃ crystal. Similar to the LiNbO₃ crystal, the LiTaO₃ crystal also has large second-order nonlinear optical coefficient, and it is expected to generate the high-power terahertz waves.

The femtosecond pulse light source is employed as the source of electromagnetic waves, but the source of electromagnetic waves is not limited to this. Further, it may be possible to employ a configuration in which the difference frequency mixing is caused by the laser light from plural sources of electromagnetic waves. The source of electromagnetic waves can be appropriately selected according to the wavelength of the terahertz waves to be generated, and the like. Further, in the embodiments described above, two lenses, the lens 3 and the lens 5, are employed in the optical system for transmitting the near-infrared light L₁ exited from the diffraction grating 2 to the LiNbO₃ crystal, but the number of lens is not limited to this. It is possible to further improve the distortion and further enhance the efficiency of the difference frequency mixing, by increasing the number of lens. Further, in FIGS. 1, 2 and 3, the LiNbO₃ crystal is formed in a prism shape whose cross-section is trapezoidal (shape obtained by combining the LiNbO₃ crystals 61 and 62 in FIG. 3), but the shape of the LiNbO₃ crystal is not limited to this.

### REFERENCE SIGNS LIST

1 Femtosecond pulse light source
2 Reflection-type diffraction grating
7 Transmission-type diffraction grating
3, 5 Lens
4 One-half wavelength plate
6, 61, 62 LiNbO₃ crystal (nonlinear optical crystal)
f₃ Focal length of lens 3
f₅ Focal length of lens 5
C₀, C₁, C₂ Pulse front of near-infrared light
L₁ Near-infrared light (first electromagnetic wave)
L₂ Terahertz wave (second electromagnetic wave)
S₀ Diffractive plane of diffraction grating
S₀′ Plane optically conjugated to diffractive plane of diffraction grating
S₁, S₂, S₃, S₄, S₅ Plane of LiNbO₃ crystal
X₁, X₂, X₃, X₄ Coordinate value in X axis in FIG. 3
θ Angle for satisfying Expression (2) of phase matching condition
AX Optical axis of near-infrared light L₁

1. A terahertz wave generator, comprising:
a source of an electromagnetic wave for outputting a first electromagnetic wave;
a diffraction element for diffracting the first electromagnetic wave;
an optical system for transmitting the first electromagnetic wave diffracted by the diffraction element; and,
a nonlinear optical crystal for generating a second electromagnetic wave with irradiation of the first electromagnetic wave transmitted by the optical system, wherein
the second electromagnetic wave is a terahertz wave in a pulse form;
the first electromagnetic wave is an electromagnetic wave in a pulse form having shorter wavelength than that of the terahertz wave;
a pulse front of the first electromagnetic wave is tilted within the nonlinear optical crystal such that the first electromagnetic wave satisfies a phase matching condition for generating the second electromagnetic wave within the nonlinear optical crystal by a nonlinear optical effect;
at least a part of a plane optically conjugated to a diffractive plane of the diffraction element is formed in the nonlinear optical crystal; and,
the diffraction element, the optical system and the nonlinear optical crystal are configured such that a direction normal to the conjugated plane in the nonlinear optical crystal and a direction normal to a plane formed by the pulse front of the first electromagnetic wave in the nonlinear optical crystal are matched with each other.

2. The terahertz wave generator according to claim 1, wherein the optical system includes a both-side telecentric optical system.

3. The terahertz wave generator according to claim 1, wherein the nonlinear optical crystal is a LiNbO₃ crystal or LiTaO₃ crystal.

4. The terahertz wave generator according to claim 1, wherein the first electromagnetic wave is a near-infrared light.
